(19) United States
(12) Patent Application Publication
(10) Pub. No.: US 2016/0352441 A1
(43) Pub. Date: Dec. 1, 2016

(54) METHOD AND APPARATUS FOR DETERMINING CHANNEL QUALITY

(71) Applicant: Beijing Zhigu Rui Tuo Tech Co., Ltd, Beijing (CN)

(72) Inventor: Weicai Huang, Beijing (CN)

(21) Appl. No.: 15/167,960

(22) Filed: May 27, 2016

(30) Foreign Application Priority Data
May 30, 2015 (CN) 201510290815.2

(51) Int. Cl. H04B 17/309; H04L 29/08

(52) U.S. Cl. CPC H04B 17/309; H04L 67/06

(57) ABSTRACT

Channel quality determination is provided. A method comprises: receiving at least one reference signal sent by a receiver through the channel when sending data to the receiver through a channel, and determining quality of the channel during a time period in which the data is sent to the receiver according to the at least one reference signal. Accordingly, the channel quality determination avoids a lag of channel quality estimation caused by respectively sending a reference signal for determining channel quality and data in different subframes, and the real-time performance and accuracy of channel quality estimation can be improved.

The present application claims the benefit of priority to Chinese Patent Application No. 201510290815.2, filed on May 30, 2015, and entitled “Method and Apparatus for Determining Channel Quality”, which application is hereby incorporated into the present application by reference herein in its entirety.

### TECHNICAL FIELD

The present application relates to the field of communication technologies, and, for example, to a method and an apparatus for determining channel quality.

### BACKGROUND

In future wireless communication services, high requirements are raised on quality of service (QoS) of an end-to-end service, for example, in scenarios such as remote control of surgical equipment or remote control of a vehicle, an end-to-end latency needs to be not greater than 1 ms, so as to avoid a sense of a lag in an operation process. To meet the extremely high QoS requirements, multiple technical challenges exist, one of which is to accurately determine channel quality to determine a proper means for data transmission.

In an existing Long Term Evolution (LTE) time division duplex (TDD) technology, a dedicated reference signal is designed, so as to help a receiver to determine channel quality.

However, the LTE TDD is implemented in a half-duplex mode, and receiving a signal and sending a signal do not happen simultaneously; and therefore, a reference signal used for determining channel quality and data are sent in different subframes respectively. Channel quality obtained by receiving the reference signal may differ greatly from that when the data is sent. In this case, if the data is still sent according to the previously obtained channel quality, it is likely that the QoS requirements cannot be met.

### SUMMARY

An example, non-limiting objective of the present application is to provide a method and an apparatus for determining channel quality.

According to a first aspect of at least one example embodiment of the present application, a method for determining channel quality is provided, comprising:

receiving at least one reference signal sent by a receiver through a channel when sending data to the receiver through the channel; and

determining quality of the channel during a time period in which the data is sent to the receiver according to the at least one reference signal.

According to a second aspect of at least one example embodiment of the present application, another method for determining channel quality is provided, comprising:

generating a reference signal; and

sending the generated reference signal to a transmitter through a channel when the transmitter sends data through the channel, wherein the reference signal is used by the transmitter to determine quality of the channel during a time period in which the data is sent through the channel.

According to a third aspect of at least one example embodiment of the present application, an apparatus for determining channel quality is provided, comprising:

a sending module, configured to send data to a receiver through a channel;

a receiving module, configured to receive at least one reference signal sent by the receiver through the channel when the sending module sends the data to the receiver through the channel; and

a determining module, configured to determine quality of the channel during a time period in which the data is sent to the receiver according to the at least one reference signal.

According to a fourth aspect of at least one example embodiment of the present application, another apparatus for determining channel quality is provided, comprising:

a generating module, configured to generate a reference signal; and

a sending module, configured to send the generated reference signal to a transmitter through a channel when the transmitter sends data through the channel, wherein the reference signal is used by the transmitter to determine quality of the channel during a time period in which the data is sent through the channel.

According to a fifth aspect of at least one example embodiment of the present application, another apparatus for determining channel quality is provided, comprising a memory and a processor, wherein the memory is configured to store an instruction, and the processor is configured to execute the instruction, so as to perform the following steps:

receiving at least one reference signal sent by a receiver through a channel when sending data to the receiver through the channel; and

determining quality of the channel during a time period in which the data is sent to the receiver according to the at least one reference signal.

According to a sixth aspect of at least one example embodiment of the present application, another apparatus for determining channel quality is provided, comprising a memory and a processor, wherein the memory is configured to store an instruction, and the processor is configured to execute the instruction, so as to perform the following steps:

generating a reference signal; and

sending the generated reference signal to a transmitter through a channel when the transmitter sends data through the channel, wherein the reference signal is used by the transmitter to determine quality of the channel during a time period in which the data is sent through the channel.

With the method and the apparatus for determining channel quality in the example embodiments of the present application, an issue relating to a lag of channel quality estimation caused by respectively sending a reference signal for determining channel quality and sending data in different subframes is avoided, and the real-time performance and accuracy of channel quality estimation can be improved.

### BRIEF DESCRIPTION OF THE DRAWINGS

FIG. 1 is a schematic flowchart of a method for determining channel quality according to an example embodiment of the present application;

FIG. 2 is a schematic flowchart of another method for determining channel quality according to an example embodiment of the present application;

FIG. 3 is a schematic flowchart of another method for determining channel quality according to an example embodiment of the present application;

FIG. 4 is a schematic flowchart of another method for determining channel quality according to an example embodiment of the present application;

FIG. 5 is a schematic flowchart of another method for determining channel quality according to an example embodiment of the present application;

FIG. 6a is a schematic diagram of a relationship between a channel quality parameter obtained according to a reference signal and time in an example application scenario of the present application;

FIG. 6b is a schematic diagram of a relationship between a channel quality parameter obtained according to a reference signal and time in another example application scenario of the present application;

FIG. 7 is a schematic flowchart of a method for determining channel quality according to another example embodiment of the present application;

FIG. 8 is a schematic structural diagram of an apparatus for determining channel quality according to an example embodiment of the present application;

FIG. 9 is a schematic structural diagram of another apparatus for determining channel quality according to an example embodiment of the present application;

FIG. 10 is a schematic structural diagram of another apparatus for determining channel quality according to an example embodiment of the present application;

FIG. 11 is a schematic structural diagram of another apparatus for determining channel quality according to an example embodiment of the present application; and

FIG. 12 is a schematic structural diagram of an apparatus for determining channel quality according to another example embodiment of the present application.

### DETAILED DESCRIPTION

Example embodiments of the present application are further described below in detail with reference to the accompanying drawings and embodiments. The following embodiments are used for describing the present application, but are not intended to limit the scope of the present application.

A person skilled in the art may understand that in the embodiments of the present application, sequence numbers of the following processes do not mean execution orders.

The execution orders of the processes should be determined according to functions and internal logic of the processes, and should not be construed as any limitation on the implementation processes of the embodiments of the present application.

In addition, the terms such as “first” and “second” in the present application are used only to differentiate different steps, devices, modules, or the like, and neither represent any specific technical meaning, nor indicate any logical relationship between the terms.

FIG. 1 is a schematic flowchart of a method for determining channel quality according to an embodiment of the present application. Referring to FIG. 1, the method comprises:

S110: When sending data to a receiver through a channel, receive at least one reference signal sent by the receiver through the channel.

S130: Determine quality of the channel during a time period in which the data is sent to the receiver according to the at least one reference signal.

With the method for determining channel quality in this embodiment of the present application, a problem in the prior art about a lag of channel quality estimation caused by respectively sending a reference signal for determining channel quality and data in different subframes is avoided, and the real-time performance and accuracy of channel quality estimation can be improved.

In this embodiment of the present application, different channels may be distinguished according to frequencies. In an optional manner, channels with a same frequency may be considered as a same channel. In another optional manner, channels a frequency offset between which is not greater than a frequency threshold may also be considered as a same channel.

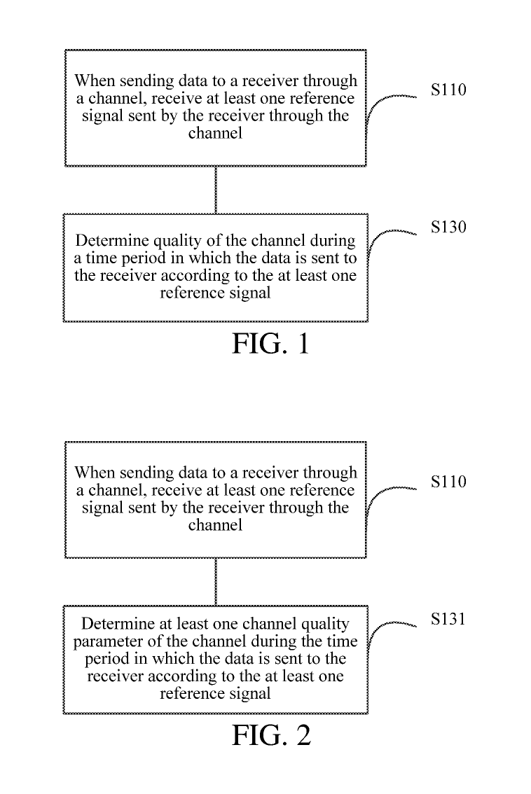

Optionally, as shown in FIG. 2, in an embodiment of the present application, the foregoing block (S130) of determining quality of the channel during a time period in which the data is sent to the receiver according to the at least one reference signal may comprise:

S131: Determine at least one channel quality parameter of the channel during the time period in which the data is sent to the receiver according to the at least one reference signal.

In this embodiment of the present application, the channel quality parameter may be a parameter associated with one or more parameters that can be used for measuring channel quality, for example, the channel quality parameter may be associated with one or more of the following parameters: signal-to-noise ratio (SNR), carrier-to-noise ratio (CNR), signal-to-interference-plus-noise ratio (SINR), carrier-to-interference-plus-noise ratio (CINR), bit error ratio (BER), channel attenuation, latency, channel state information (CSI), channel transmission matrix, channel quality indicator (CQI), and the like.

The at least one channel quality parameter during the time period in which the data is sent to the receiver can be obtained according to the at least one reference signal, thereby accurately determining a change status of the channel quality in the entire data sending process.

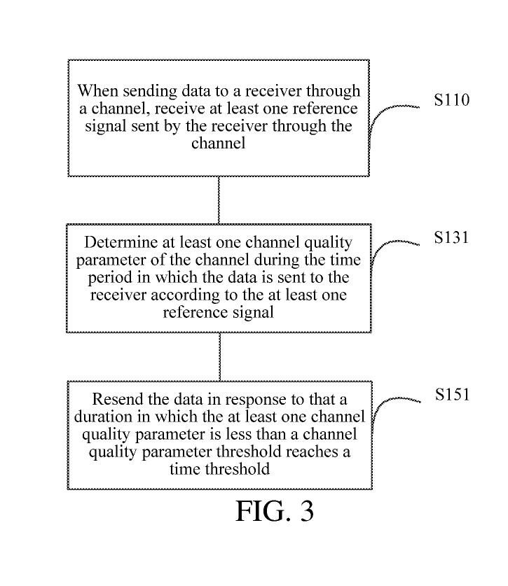

Optionally, as shown in FIG. 3, in an example embodiment of the present application, after S131, the method may further comprise:

S151: Resend the data in response to that a duration in which the at least one channel quality parameter is less than a channel quality parameter threshold reaches a time threshold.

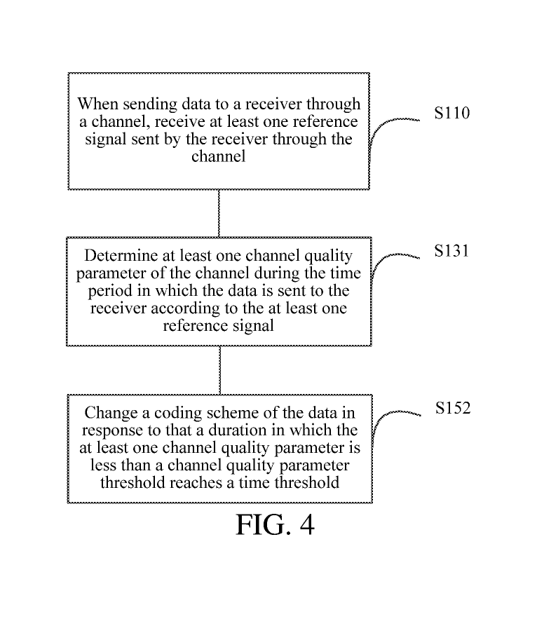

Optionally, as shown in FIG. 4, in another example embodiment of the present application, after S131, the method may further comprise:

S152: Change a coding scheme of the data in response to that a duration in which the at least one channel quality parameter is less than a channel quality parameter threshold reaches a time threshold.

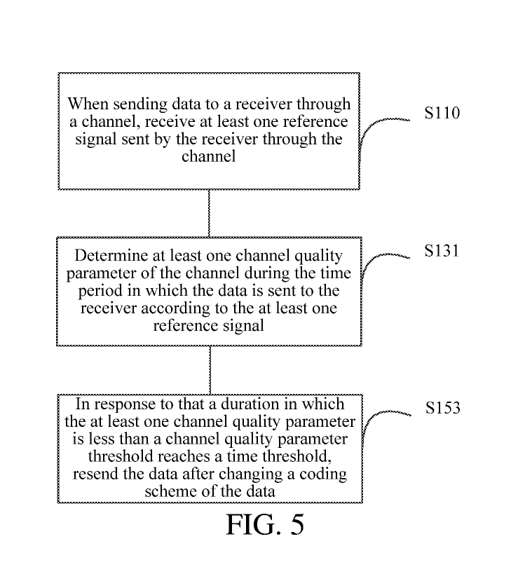

Optionally, as shown in FIG. 5, in another example embodiment of the present application, after S 131, the method may further comprise:

S153: In response to that a duration in which the at least one channel quality parameter is less than a channel quality parameter threshold reaches a time threshold, resend the data after changing a coding scheme of the data.

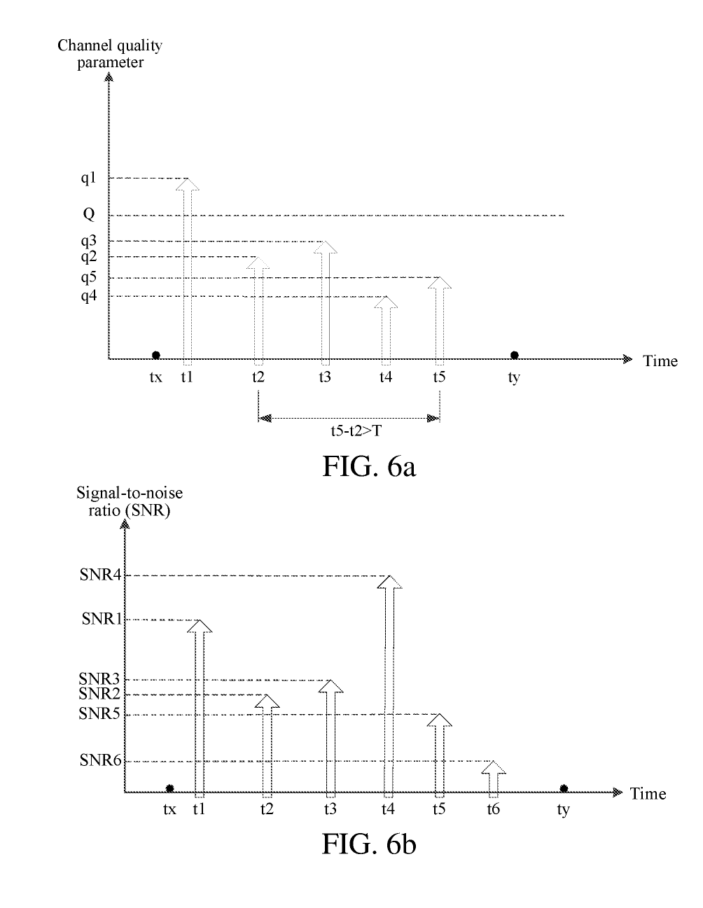

Descriptions are made below by using a specific scenario as an example. As shown in FIG. 6a, it is assumed that a time period from a time point tx to a time point ty is the time period in which the data is sent to the receiver in this embodiment of the present application. In this time period, data is sent to the receiver on the one hand and five reference signals from the receiver are received on the other. Channel quality parameters q1, q2, q3, q4, and q5 at time points t1, t2, t3, t4, and t5 are respectively obtained by calculation according to the five reference signals. Exemplarily, q1, q2, q3, q4, and q5 may be SNRs of the channel at the time points t1, t2, t3, t4, and t5 respectively; or q1, q2, q3, q4, and q5 may be parameters associated with SNRs and EBRs of the channel at the time points t1, t2, t3, t4, and t5 respectively; or q1, q2, q3, q4, and q5 may be parameters associated with other parameters for measuring channel quality at the time points t1, t2, t3, t4, and t5 respectively, which are not specifically limited in this embodiment of the present application. In this scenario, it is assumed that q2, q3, q4, and q5 all are less than a channel quality parameter threshold Q, and a duration in which a channel quality parameter is less than the channel quality parameter threshold (that is, t2 to t5) exceeds a time threshold T. Thus, it can be determined that channel quality is degraded in the time period from t2 to t5, and a portion of the data sent in this time period may not be received by the receiver, or the portion of the data sent in this time period is received by the receiver but a decoding error rate is relatively high. Therefore, in this embodiment of the present application, current data transmission may be ended at the time point t5, and current data may be retransmitted in a current subframe or a next subframe available for sending, so as to ensure that the receiver can receive the portion of the data. Alternatively, current data transmission may not be interrupted, but a coding scheme of data is changed after the time point t5, for example, an LTE physical shared channel can support three coding schemes: QPSK, 16QAM, and 64QAM; these three coding schemes require different channel conditions; and generally, a higher coding scheme (QPSK<16QAM<64QAM) indicates a higher requirement on channel quality. Therefore, if current channel quality is poor, the decoding error rate of the data of the receiver may be reduced by descending the coding scheme. Alternatively, current data transmission is ended after the time point t5, and current data is retransmitted in a current subframe or a next subframe available for sending after a coding scheme of the data is changed.

In another application scenario, as shown in FIG. 6b, it is assumed that a time period from a time point tx to a time point ty is the time period in which the data is sent to the receiver in this embodiment of the present application. In this time period, data is sent to the receiver on the one hand and six reference signals from the receiver are received on the other. SNRs of the channel SNR1, SNR2, SNR3, SNR4, SNR5, and SNR6 at time points t1, t2, t3, t4, t5, and t6 are respectively obtained by calculation according to the six reference signals. In this scenario, in a time period from t1 to t2, a channel quality parameter may be a parameter q12 associated with (SNR1+SNR2); in a time period from t2 to t3, a channel quality parameter may be a parameter q23 associated with (SNR2 +SNR3); in a time period from t3 to t4, a channel quality parameter may be a parameter q34 associated with (SNR3+SNR4); in a time period from t4 to t5, a channel quality parameter may be a parameter q45 associated with (SNR4+SNR5); and in a time period from t5 to t6, a channel quality parameter may be a parameter q56 associated with (SNR5+SNR6).

Assuming that q56 is less than a channel quality parameter threshold Q, it can be considered that channel quality is degraded in the time period from t5 to t6, and a portion of the data sent in this time period may not be received by the receiver, or the portion of the data sent in this time period is received by the receiver but a decoding error rate is relatively high. Therefore, in this embodiment of the present application, current data transmission may be ended after the time point t6, and current data may be retransmitted in a current subframe or a next subframe available for sending, so as to ensure that the receiver can receive the portion of the data. Alternatively, current data transmission may not be interrupted, but a coding scheme of data is changed after the time point t6. Alternatively, current data transmission is ended after the time point t6, and current data is retransmitted in a current subframe or a next subframe available for sending after a coding scheme of the data is changed.

Optionally, in an example embodiment of the present application, an initial value of the channel quality parameter threshold and/or an initial value of the time threshold may be pre-determined according to empirical values. In this embodiment of the present application, the channel quality parameter threshold and/or the time threshold may not be changed in a data transmission process, or the channel quality parameter threshold and/or the time threshold may be adjusted according to feedback information of the receiver.

For example, receiving capabilities or processing capabilities of different receivers may be different, or may be changed due to impact of environmental factors, and when the initial value of the channel quality parameter threshold and/or the initial value of the time threshold is determined according to empirical values, an average status is mainly considered. The threshold set in that way may not be proper for different receivers. Using data retransmission as an example, for a receiver with a relatively high receiving capability and processing capability, the volume of retransmitted data may be excessive, and in this case, the threshold may be properly increased, so as to raise a trigger condition of the data retransmission; for a receiver with a relatively low receiving capability and processing capability, some data that needs to be retransmitted may not be retransmitted, and in this case, the threshold may be properly decreased, so as to lower a trigger condition of the data retransmission.

Exemplarily, the feedback information of the receiver may comprise but is not limited to: an identifier of a portion, which is correctly received, of the data, such as a sequence number of a segment of a data packet which is correctly received; or an identifier of a lost portion of the data, such as a sequence number of a segment of a data packet that is not received; or a decoding error rate of a portion, which is received, of the data ; or indication information used for instructing to increase the channel quality parameter threshold and/or the time threshold; or indicating information used for instructing to decrease the channel quality parameter threshold and/or the time threshold.

In a possible implementation, the time threshold may be set to 0, that is, if it is determined that any channel quality parameter is less than the channel quality parameter threshold, wherein the any channel quality parameter may be a channel quality parameter corresponding to a time point or a channel quality parameter corresponding to a time period, data retransmission and/or change of a coding scheme may be triggered without considering a duration in which the channel quality parameter is less than the channel quality parameter threshold.

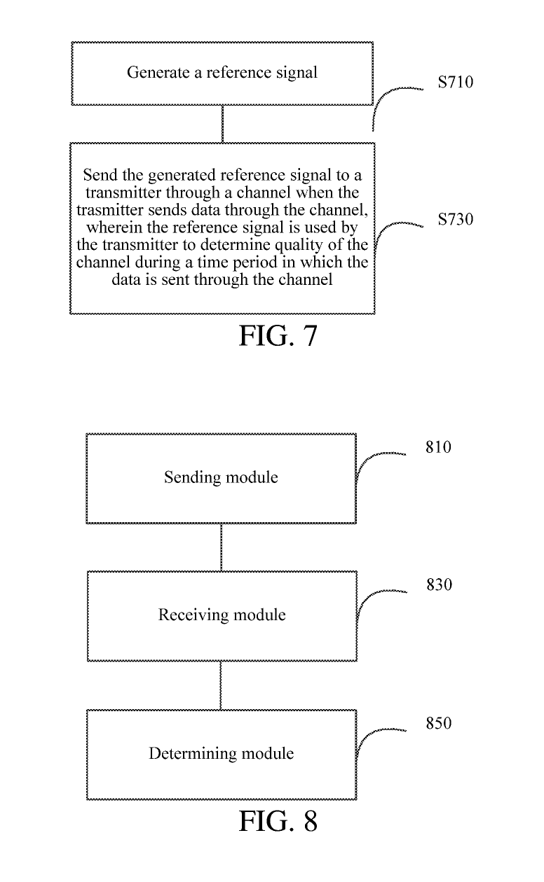

FIG. 7 is a schematic flowchart of a method for determining channel quality according to another embodiment of the present application. Referring to FIG. 7, the method comprises:

S710: Generate a reference signal.

S730: Send the generated reference signal to a transmitter through a channel when the transmitter sends data through the channel, wherein the reference signal is used by the transmitter to determine quality of the channel during a time period in which the data is sent through the channel.

With the method for determining channel quality in this embodiment of the present application, a problem in the prior art about a lag of channel quality estimation caused by respectively sending a reference signal for determining channel quality and data in different subframes is avoided, and the real-time performance and accuracy of channel quality estimation can be improved.

Optionally, in this embodiment of the present application, a payload of the reference signal may be null; and optionally, a header of the reference signal may be the same as a header part of the data.

In an example embodiment of the present application, in order to save bandwidth resources, only one reference signal may be generated and sent, so as to help the transmitter to determine the channel quality.

In another example embodiment of the present application, in order to determine a trend of changes of channel quality with time more accurately, two or more than two reference signals may be generated and sent, so as to help the transmitter to determine the channel quality.

The reference signals may be continuously sent during the time period in which the transmitter sends the data through the channel, or be sent at intervals, for example, the reference signals may be sent one by one at an interval of at least one symbol.

Optionally, two parties of communication may start data transmission after the channel is available, and therefore, after the channel is available, it can be considered that the transmitter starts sending the data through the channel, and at the same time, the sending of the at least one reference signal may be started.

Optionally, the channel may be a dedicated channel or a shared channel.

FIG. 8 is a schematic structural diagram of an apparatus for determining channel quality according to an embodiment of the present application. Referring to FIG. 8, the apparatus comprises:

a sending module 810, configured to send data to a receiver through a channel;

a receiving module 830, configured to receive at least one reference signal sent by the receiver through the channel when the sending module sends the data to the receiver through the channel; and

a determining module 850, configured to determine quality of the channel during a time period in which the data is sent to the receiver according to the at least one reference signal.

With the apparatus for determining channel quality in the embodiment of the present application, a problem in the prior art about a lag of channel quality estimation caused by respectively sending a reference signal for determining channel quality and data in different subframes is avoided, and the real-time performance and accuracy of channel quality estimation can be improved.

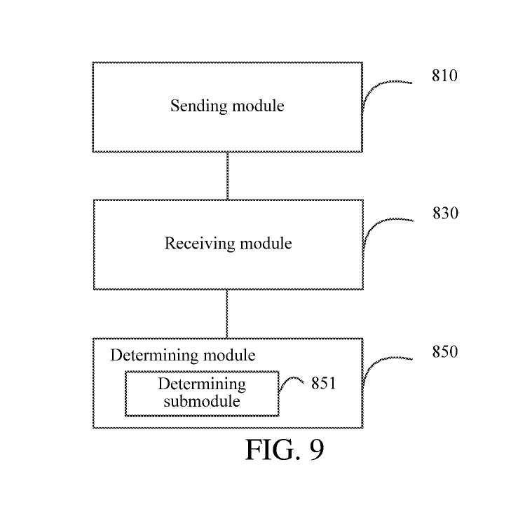

Optionally, as shown in FIG. 9, the determining module 850 comprises:

a determining submodule 851, configured to determine at least one channel quality parameter of the channel during the time period in which the data is sent to the receiver according to the at least one reference signal.

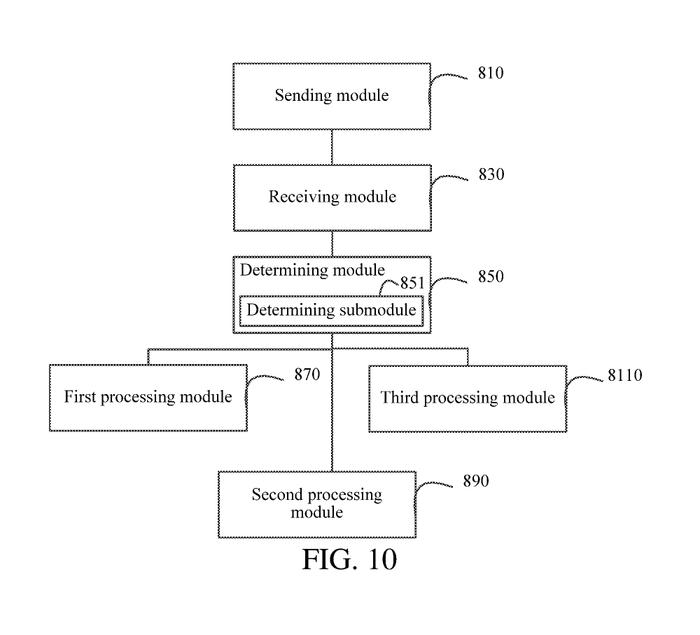

Optionally, as shown in FIG. 10, the apparatus may further comprise:

a first processing module 870, configured to resend the data in response to that a duration in which the at least one channel quality parameter is less than a channel quality parameter threshold reaches a time threshold;

a second processing module 890, configured to change a coding scheme of the data in response to that a duration in which the at least one channel quality parameter is less than a channel quality parameter threshold reaches a time threshold; and/or

a third processing module 8110, configured to resend the data after changing a coding scheme of the data in response to that a duration in which the at least one channel quality parameter is less than a channel quality parameter threshold reaches a time threshold.

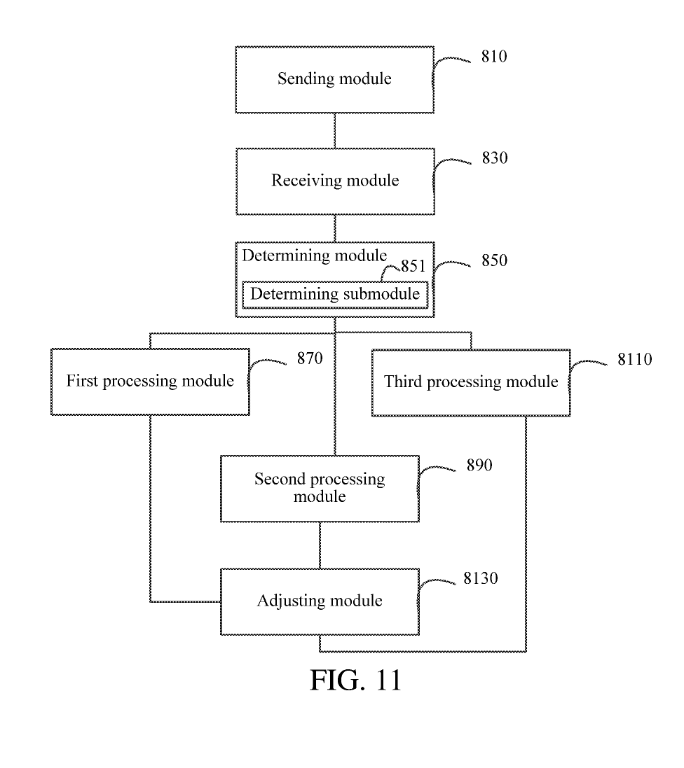

Optionally, as shown in FIG. 11, the apparatus may further comprise:

an adjusting module 8130, configured to adjust the channel quality parameter threshold and/or the time threshold according to feedback information of the receiver.

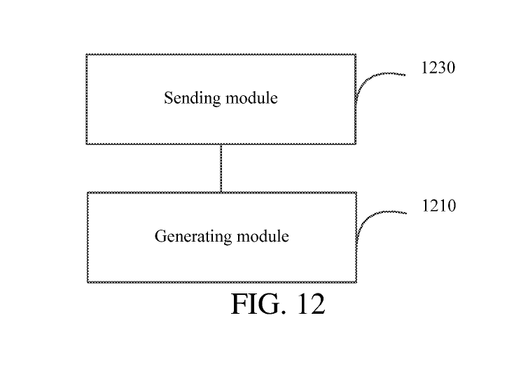

FIG. 12 is a schematic structural diagram of an apparatus for determining channel quality according to another embodiment of the present application. Referring to FIG. 12, the apparatus comprises:

a generating module 1210, configured to generate a reference signal; and

a sending module 1230, configured to send the generated reference signal to a transmitter through a channel when the transmitter sends data through the channel, wherein the reference signal is used by the transmitter to determine quality of the channel during a time period in which data is sent through the channel.

With the apparatus for determining channel quality in the embodiment of the present application, a problem in the prior art about a lag of channel quality estimation caused by respectively sending a reference signal for determining channel quality and data in different subframes is avoided, and the real-time performance and accuracy of channel quality estimation can be improved.

Another embodiment of the present application further provides an apparatus for determining channel quality, comprising a memory and a processor, wherein the memory is configured to store an instruction, and the processor is configured to execute the instruction, so as to perform the following steps:

receiving at least one reference signal sent by a receiver through a channel when sending data to the receiver through the channel; and

determining quality of the channel during a time period in which the data is sent to the receiver according to the at least one reference signal.

The processor may be a central processing unit (CPU), or an application specific integrated circuit (ASIC), or may be configured to be one or more integrated circuits configured to implement an embodiment of a method for determining channel quality.

The memory may be any medium that can store program code, such as a USB flash drive, a removable hard disk, a read-only memory (ROM), a random access memory (RAM), a magnetic disk, or an optical disc.

Another embodiment of the present application further provides an apparatus for determining channel quality, comprising a memory and a processor, wherein the memory is configured to store an instruction, and the processor is configured to execute the instruction, so as to perform the following steps:

generating a reference signal; and

sending the generated reference signal to a transmitter through a channel when the transmitter sends data through the channel, wherein the reference signal is used by the transmitter to determine quality of the channel during a time period in which the data is sent through the channel.

It may be clearly understood by a person skilled in the art that, for the purpose of convenient and brief descriptions, the foregoing method for determining channel quality may be implemented by the foregoing apparatus for determining channel quality of the present application, reference may be made to the description of corresponding processes in the foregoing embodiments of the method for determining channel quality, and details are not described herein again.

A person of ordinary skill in the art may be aware that, units and method steps of the examples that are described in conjunction with the embodiments disclosed in this specification may be implemented by electronic hardware or a combination of computer software and electronic hardware. Whether the functions are performed by hardware or software depends on particular applications and design constraint conditions of the technical solution. A person skilled in the art may use different methods to implement the described functions for each particular application, but it should not be considered that the implementation goes beyond the scope of the present application.

When the functions are implemented in a form of a software functional unit and sold or used as an independent product, the functions may be stored in a computer-readable storage medium. Based on such an understanding, the technical solutions of the present application essentially, or the part contributing to the prior art, or a part of the technical solutions may be implemented in a form of a software product. The computer software product is stored in a storage medium and comprises several instructions for instructing a computer device (which may be a personal computer, a controller, a network device, or the like) to perform all or some of the steps of the methods described in the embodiments of the present application. The foregoing storage medium comprises: any medium that can store program code, such as a USB flash drive, a removable hard disk, a ROM, a RAM, a magnetic disk, or an optical disc.

The foregoing example embodiments are merely used to describe the present application, but are not intended to limit the present application. A person of ordinary skill in the art may further make various variations and modifications without departing from the spirit and scope of the present application. Therefore, all the equivalent technical solutions also fall within the scope of the present application, and the patent protection scope of the present application should be subject to the claims.

What is claimed is:

1. A method, comprising:
receiving, by a system comprising a processor, at least one reference signal from a receiver through a channel when sending data to the receiver through the channel; and
determining a quality of the channel during a time period in which the data is sent to the receiver according to the at least one reference signal.

2. The method of claim 1, wherein the determining the quality of the channel comprises:
determining at least one channel quality parameter of the channel during the time period in which the data is sent to the receiver according to the at least one reference signal.

3. The method of claim 2, further comprising:
resending the data in response to determining that a duration, in which the at least one channel quality parameter is less than a channel quality parameter threshold, reaches a time threshold.

4. The method of claim 2, further comprising:
changing a coding scheme of the data in response to determining that a duration, in which the at least one channel quality parameter is less than a channel quality parameter threshold, reaches a time threshold.

5. The method of claim 2, further comprising:
resending the data after changing a coding scheme of the data in response to determining that a duration, in which the at least one channel quality parameter is less than a channel quality parameter threshold, reaches a time threshold.

6. The method of claim 3, further comprising:
adjusting the channel quality parameter threshold or the time threshold according to feedback information of the receiver.

7. The method of claim 2, wherein the at least one channel quality parameter is associated with at least one of:
a signal-to-noise ratio, a carrier-to-noise ratio, a signal-to-interference-plus-noise ratio, a carrier-to-interference-plus-noise ratio, a bit error ratio, a channel attenuation, a latency, channel state information, a channel transmission matrix, or a channel quality indicator.

8. A method, comprising:
generating, by a system comprising a processor, a reference signal; and
sending the reference signal through a channel when a transmitter sends data through the channel, wherein the reference signal is used by the transmitter to determine a quality of the channel during a time period in which the data is sent through the channel.

9. The method of claim 8, wherein the generating the reference signal comprises:
generating one reference signal.

10. The method of claim 8, wherein the generating the reference signal comprises:
generating at least two reference signals.

11. An apparatus, comprising:
a memory that stores executable modules; and
a processor, coupled to the memory, that executes or facilitates execution of the executable modules, the executable modules comprising:
a sending module configured to send data to a receiver via a channel;
a receiving module configured to receive a reference signal from the receiver via the channel when the sending module sends the data to the receiver via the channel; and
a determining module configured to determine a quality of the channel during a time period in which the data is sent to the receiver according to the reference signal.

12. The apparatus of claim 11, wherein the determining module comprises:
a determining submodule configured to determine a channel quality parameter of the channel during the time period in which the data is sent to the receiver according to the reference signal.

13. The apparatus of claim 12, wherein the executable modules further comprise:
a first processing module configured to resend the data in response to a determination that a duration, in which the channel quality parameter is less than a channel quality parameter threshold, has reached a time threshold.

14. The apparatus of claim 12, wherein the executable modules further comprise:
a first processing module configured to change a coding scheme of the data in response to a determination that a duration, in which the channel quality parameter is less than a channel quality parameter threshold, has reached a time threshold.

15. The apparatus of claim 12, wherein the executable modules further comprise:
a first processing module configured to resend the data after changing a coding scheme of the data in response to a determination that a duration, in which the channel quality parameter is less than a channel quality parameter threshold, has reached a time threshold.

16. The apparatus of claim 13, wherein the executable modules further comprise:
an adjusting module configured to adjust the channel quality parameter threshold or the time threshold according to feedback information of the receiver.

17. An apparatus, comprising:
a memory that stores executable modules; and
a processor, coupled to the memory, that executes or facilitates execution of the executable modules, the executable modules comprising:
a generating module configured to generate a reference signal; and
a sending module configured to send the reference signal to a transmitter via a channel when the transmitter sends data via the channel, wherein the reference signal is used by the transmitter to determine a quality of the channel during a time period in which data is sent via the channel.

18. An apparatus, comprising a memory and a processor, wherein the memory is configured to store an instruction, and the processor is configured to execute the instruction, so as to perform operations, comprising:
receiving a reference signal from a receiver via the channel concurrently with sending data to the receiver via the channel; and
determining quality of the channel during a time period in which the data is sent to the receiver according to the reference signal.

19. An apparatus, comprising a memory and a processor, wherein the memory is configured to store an instruction, and the processor is configured to execute the instruction, so as to perform operations, comprising:
generating a reference signal; and
sending the reference signal via a channel to a transmitter concurring with the transmitter sending data via the channel, wherein the reference signal is used by the transmitter to determine a quality of the channel during a time period in which the data is sent via the channel.

20. A computer readable storage device comprising executable instructions that, in response to execution, cause a device comprising a processor to perform operations, comprising:
receiving a reference signal from a receiver through a channel when sending data to the receiver through the channel; and
determining a quality of the channel during a time period in which the data is sent to the receiver according to the reference signal.

21. A computer readable storage device comprising executable instructions that, in response to execution, cause a device comprising a processor to perform operations, comprising:
generating a reference signal; and
sending the reference signal via a channel when a transmitter sends data via the channel, wherein the reference signal is used by the transmitter to determine a quality of the channel during a time period in which the data is sent via the channel.
